(19) United States
(12) Patent Application Publication
(10) Pub. No.: US 2014/0222471 A1
(43) Pub. Date: Aug. 7, 2014

(54) METHOD TO VERIFY GASIFIER QUALITY AND PERFORMANCE

(71) Applicant: How Kiap Gueh, Singapore (SG)

(72) Inventor: How Kiap Gueh, Singapore (SG)

(21) Appl. No.: 14/162,327

(22) Filed: Jan. 23, 2014

(30) Foreign Application Priority Data
Jan. 23, 2013 (SG) 201300575-6

(51) Int. Cl. G06Q 30/00

(52) U.S. Cl. CPC G06Q 30/012; G06Q 40/08
USPC 705/4

(57) ABSTRACT

The application provides a computer implemented method for quality and performance inspection of a gasifier. The method comprises a step of identifying a gasifier, a step of identifying one or more feed to be delivered into at least one identified inlet conduit belonging to the identified gasifier, and a step of identifying one or more gas, solids, or liquid product is to be collected from at least one identified outlet conduit belonging to the identified gasifier. The identified gasifier is then inspected against said at least one identified inlet conduit and said at least one identified outlet conduit to determine a match against the step of identifying one or more feed and the step of identifying one or more gas, solids, or liquid product. A primary certificate of conformance is later generated based on the result of the step of inspecting identified gasifier. The method also comprises a step of operating identified gasifier at a remote operating site for a determined time period and delivering one or more identified feed into at least one identified inlet conduit and collecting one or more identified gas, solids, or liquid product from at least one identified outlet conduit, and a step of generating one or more data values from at least the step of operating identified gasifier. A secondary certificate of conformance is then generated based at least from the result of the step of operating identified gasifier, the step of generating one or more data values or a combination.

### CROSS-REFERENCE TO RELATED APPLICATIONS

This application claims priority to Singapore Application No. 201300575-6, tiled Jan. 23, 2013, which is incorporated by reference herein in its entirety.

### BRIEF ABSTRACT OF THE INVENTION

The invention relates to a method for the production of a crude synthesis gas that contains CO and H2.

The present invention relates to a method by which a gasifier apparatus within a gasification plant is verified against a rated or designed performance envelope by using one or more input parameters such as Gcv, Kd and Tlv values resultant from the operating output of the gasifier apparatus, so as to plot and derive a time-sensitive relationship between the efficiency by which gasifier apparatus converts carbon present in one or more feed fuel to synthesis gas.

### TECHNICAL FIELD AND BACKGROUND

Synthesis gases are gas mixtures that are used in synthesis reactions and consist predominantly of carbon monoxide and hydrogen. For some CO/H2 combinations, special designations such as water gas, cracked gas, methanol synthesis gas, or oxo gas have established themselves, based on their origin or their use. Synthesis gas can serve as a starting substance mixture for the production of liquid fuels. For example, synthesis gas is used in the Fischer-Tropsch process, to produce diesel fuel. Gasoline fuels can be produced using the MTG (methanol to gasoline) process, in which the synthesis gas is first converted to methanol, which is later converted to gasoline, in further method steps.

Fundamentally, all carbonaceous substances can be used for synthesis gas production. These include not only the fossil fuels coal, petroleum, shale ore, tar sands, and natural gas, but also other starting materials such as plastics, peat, discarded rubber, wood or other biomass, such as municipal or agricultural wastes, for example.

If solids are used, these must first be shredded, in complicated manner, so that a crude synthesis gas can be produced by means of partial oxidation or steam cracking. Afterwards, the crude synthesis gas is processed in further steps. All of these measures lead to high investment costs, which are a barrier for the production of liquid fuels from synthesis gas.

The crude synthesis gas produced using the method according to the invention can be used in different production methods. For example, it can be used for the production of fuels, within the scope of a Fischer-Tropsch process. Likewise, it can be used within the scope of methanol synthesis. The methanol can then be converted to gasoline, according to the MTG process. Also, it is possible that the synthesis gas is converted to SNG (synthetic natural gas). Likewise, the synthesis gas that is produced can be used for oxo synthesis or for ammonia production.

A warranty for quality and performance is provided for delivered gasification products to ensure that a gasification plant owner receives only a quality product. A warranty outlines a guaranteed quality and compensations to be provided to the owner for a not kept an established quality. On the other hand, it also usually outlines operation and maintenance conditions under which a warranty provided will be valid and which must be respected by a plant owner. During sales and subsequent operational maintenance of such products, warranties play an important role, because recently they became a significant tool of competition fight and also because providing warranties has significant economic impacts on the supplier or manufacturer. Providing the warranty is always accompanied with additional costs, called warranty costs.

Complications arise in the area of selling and providing gasification and gasification related equipment to owners “plant owners”, since a gasifier apparatus may be built to a required or owner accepted quality, it does not necessarily imply that the apparatus can provide the performance warranted.

There can be a large amount of variability in the composition of feed fuel that is used as input to the gasifier apparatus, adding to the problems of verifying the actual performance of the gasifier product when compared to the rated or designed performance envelopes.

Many types of gasification plants currently exists, however, it is difficult to implement warranty and performance tests on a new gasifier plant that is independently conducted without bias, as manufacturers of the gasifier plant is usually inclined to run such performance tests during the plant's commissioning in-house.

A trained individual or individuals traditionally perform insurance underwriting. A given application for insurance (also referred to as an “insurance application”) may be compared against a plurality of underwriting standards set by an insurance company. The insurance application may be classified into one of a plurality of risk categories available for a type of insurance coverage requested by an applicant. The risk categories then affect a premium paid by the applicant, e.g., the higher the risk category, the higher the premium. A decision to accept or reject the application for insurance may also be part of this risk classification, as risks above a certain tolerance level set by the insurance company may simply be rejected.

There can be a large amount of variability in the insurance underwriting process when performed by individual underwriters. Typically, underwriting standards cannot cover all possible cases and variations of an application for insurance. The underwriting standards may even be self-contradictory or ambiguous, leading to uncertain application of the standards. The subjective judgment of the underwriter will almost always play a role in the process. Variation in factors such as underwriter training and experience, and a multitude of other effects can cause different underwriters to issue different, inconsistent decisions. Sometimes these decisions can be in disagreement with the established underwriting standards of the insurance company, while sometimes they can fall into a “gray area” not explicitly covered by the underwriting standards.

Further, there may be an occasion in which an underwriter's decision could still be considered correct, even if it disagrees with the written underwriting standards. This situation can be caused when the underwriter uses his/her own experience to determine whether the underwriting standards may or should be interpreted and/or adjusted. Different underwriters may make different determinations about when these adjustments are allowed, as they might apply stricter or more liberal interpretations of the underwriting standards. Thus, the judgment of experienced underwriters may be in conflict with the desire to consistently apply the underwriting standards.

There is a need for a standardized process or series of steps to validate and verify the performance (A), and quality (B) of a gasifier for purposes of warranty calculation and plant insurance planning.

### TERMS AND DEFINITIONS

A “gasifier,” as defined herein, refers to a reaction environment wherein a carbon carrying feedstock material is converted into a gas through the action of heat and, possibly, one or more reactive gases such as oxygen, air, carbon dioxide (CO2), and/or steam. Gasifier can mean partial oxidation gasifier, a steam reformer, an autothermal reformer, and combinations thereof.

“Synthesis gas,” or “syngas,” as defined herein, generally refers to a mixture of carbon monoxide (CO) and hydrogen (H2) produced by gasification in a gasifier.

Approximating language, as used herein throughout the specification and claims, may be applied to modify any quantitative representation that could permissibly vary with out resulting in a change in the basic function to which it is related. Accordingly, a value modified by a term or terms, such as “about,” is not limited to the precise value specified. In some instances, the approximating language may correspond to the precision of an instrument for measuring the value. In some instances, the term about can denote a value within a range of ±10% of the quoted value.

Terms “heating value,” “calorific value,” “caloric value,” are interchangeably used within this description.

“Feed”, “feed fuel”, “feedstock”, as used herein throughout the specification and claims, may refer to coal, biomass, municipal solid waste (MSW), refuse-derived fuel (RDF), industrial waste, sewage, raw sewage, peat, scrap rubber, shale ore, tar sands, crude oil, natural gas, low-BTU blast furnace off-gas, flue gas exhaust, or a combination thereof.

Refuse-derived fuel (RDF), which is generally produced by shredding municipal solid waste, consists largely of organic components of municipal waste such as plastics and biodegradable waste. Non-combustible materials such as glass and metals are removed mechanically and the resultant material compressed into pellets, bricks, or logs and used for conversion to combustible gas, which can itself be used for electricity generation or the like.

“Feed”, “feed fuel”, “feedstock”, as used herein throughout the specification and claims, can also mean agricultural feedstocks, forestry-based feedstocks, municipal solid waste (MSW), MSW can include the following: selected from the group consisting of waste plastics, used tires, paper, scrap-wood, food-processing waste, sewage, sludge, green-waste.

“Feed”, “feed fuel”, “feedstock”, as used herein throughout the specification and claims can also mean fossil material such as cede oil, tar sands, shale oil, coal, natural gas, and combinations thereof,

“Feed”, “feed fuel”, “feedstock”, as used herein throughout the specification and claims, can also mean coal mine tailings, coal waste, coal fines, coal water slurry, coal-liquid mixtures, and combinations thereof.

“Feed”, “feed fuel”, “feedstock”, as used herein throughout the specification and claims, can also mean refinery residual material comprises low-value carbonaceous by-products selected from the group consisting of asphaltenes, tars, and combinations thereof.

Flue gas exhaust also refers to gas containing CO, CO.sub.2 (carbon dioxide), nitrogen, nitrogen oxides and other particulates, sulphur compounds, soot, tar, or combustion exhaust gases generated from fossil-fuel power plants such as oil, coal, gas-fired powerplants, boilers, steam generators, combustion burners, gas turbine exhausts, reciprocating engine exhaust gases.

Coal refers to a common fossil fuel, the most common classification is based on the calorific value and composition of the coal.

Coal is of importance as a fuel for power generation now and in the future since there are a lot of coal reserves, and the coal reserves are hardly unevenly distributed over the world.

ASTM (American Society for Testing and Materials) standard D388 classifies the coals by rank. This is based on properties such as fixed carbon content, volatile matter content, calorific value and agglomerating character.

Broadly, the coals can be categorized as “high rank coal” and “low rank coal,” which denote high-heating-value, lower ash content and lower heating value, higher ash content coals, respectively.

Low-rank coals include lignite and sub-bituminous coals. These coals have lower energy content and higher moisture levels.

High-rank coals, including bituminous and anthracite coals, contain more carbon than lower-rank coals and correspondingly have a much higher energy content. Some coals with intermediate properties may be termed as “medium rank coal.”

The term biomass covers a broad range of materials that offer themselves as fuels or raw materials and are characterized by the fact that they are derived from recently living organisms (plants and animals).

This definition clearly excludes traditional fossil fuels, since although they are also derived from plant (coal) or animal (oil and gas) life, it has taken millions of years to convert them to their current form.

Thus the term biomass includes feeds derived from material such as wood, woodchips, sawdust, bark, seeds, straw, grass, and the like, from naturally occurring plants or purpose grown energy crops.

It includes agricultural and forestry wastes. Agricultural residue and energy crops may further include husks such as rice husk, coffee husk etc., maize, corn stover, oilseeds, cellulosic fibers like coconut, jute, and the like.

Agricultural residue also includes material obtained from agro-processing industries such as deoiled residue, gums from oil processing industry, bagasse from sugar processing industry, cotton gin trash and the like. It also includes other wastes from such industries such as coconut shell, almond shell, walnut shell, sunflower shell, and the like.

In addition to these wastes from agro industries, biomass may also include wastes from animals and humans.

In some embodiments, the biomass includes municipal waste or yard waste, sewage sludge and the like. In some other embodiments, the term biomass includes animal farming byproducts such as piggery waste or chicken litter. The term biomass may also include algae, microalgae, and the like.

Thus, biomass covers a wide range of material, characterized by the fact that they are derived from recently living plants and animals. All of these types of biomass contain carbon, hydrogen and oxygen, similar to many hydrocarbon fuels; thus the biomass can be used to generate energy, biomass includes components such as oxygen, moisture and ash and the proportion of these depends on the type and source of the biomass used.

“Refinery residual,” or “refinery resid,” gas defined herein, generally refers to the heaviest by-product fractions produced at a refinery. Asphaltenes are a type of refinery resid, as is coker coke.

### SUMMARY

The present invention relates to a method by which a gasifier apparatus within a gasification plant is verified against a rated or designed performance envelope by using one or more input parameters such as Gcv, Kd and Tlv values resultant from the operating output of the gasifier apparatus, so as to plot and derive a time-sensitive relationship between the efficiency by which gasifier apparatus converts carbon present in one or more feed fuel to synthesis gas.

### GENERALIZED PROCESS AND STEPS

Feed designated for a gasifier is first categorized into various feed classes. (E.g. coal and wood into class “A”, rubber and RDF into class “B”, etc).

The gasifier's material inputs such as oxidant gas, feed classes (“A”, “B”, etc) are identified and matched to the inlet sections and material outputs such as the crude syngas, by-product slag or ash are identified and matched to specific outlet sections of the gasifier. A primary certificate is issued to document that no other material inputs or “unauthorized” inlet or outlet sections are present in the gasifier—“tamper-free”, meaning that other than the identified inlet and outlet sections of the identified gasifier that are matched to the identified inlet or outlet materials, no other conduits are present that may withdraw or introduce unidentified inlet or outlet materials into or from the known and identified reaction environment.

Feed classes are delivered along with the “authorized” material inputs into the gasifier to generate crude syngas, the chemical analysis of the feed classes delivered into the gasifier are then grouped into a data-set that also contains the crude syngas chemical composition, kcal/kg or energy content. A secondary certificate is issued to document that the specific feed classes delivered into an identified or “known” gasifier having a “tamper-free” (the Primary) certificate are matched to the data-set containing the information related to the crude syngas produced from the known gasifier.

It is therefore advantageous to the operator or owner of the gasifier as the primary certificate is issued upon the inspection of hardware or physical aspects of the gasifier that is delivered by the manufacturer, and such a certificate may be issued upon performance of such inspection by a third party to verify such a gasifier.

It is further advantageous to the operator or owner of the gasifier as the secondary certificate is issued upon the verification of the actual performance of the gasifier based on a known category of feeds identified, against a determined or pre-defined set of performance benchmarks or parameters, wherein such verification may be performed by yet another party that is not the same entity as the one that performed inspection related to the primary certificate.

### DRAWINGS

FIG. 1 illustrates the steps in relation to the generalized method described in accordance to the present invention and Example 1.

FIG. 2 illustrates the steps in relation to the generalized method described in accordance to the present invention and Example 2.

FIG. 3 illustrates the steps in relation to the generalized method described in accordance to the present invention and Example 3.

FIG. 4 illustrates an exemplary embodiment of a system for performing a computer implemented method of evaluating a gasifier performance according to the present specification.

FIG. 5 illustrates a schematic implementation diagram of a computer implemented method according to the present specification.

### EXAMPLES, EMBODIMENTS & DISCLOSURE

Generally, the gasifier is identified and the reaction environment is documented to the user. The intended feed or multiplicity of feed to be converted into crude syngas within the identified gasifier is grouped into at least one category or “class”.

The reaction environment documented will indicate the known output of the identified gasifier, mainly the principal product crude syngas, alongside by-products such as slag, ash, etc.

In some reaction environments additional input material other than the identified feed category or class may be required, these are added into either another category or class.

An inspection is performed on the actual gasifier to document and record the inlet and outlet conduits leading into and out from the reaction environment within the identified gasifier.

Once such an inspection is satisfactory, whereby the identified inlet and outlet conduits or “sections” are traced and matches the documented reaction environment of the identified gasifier, a primary certificate is generated to provide indication of conformity to the above design to actual build worthiness.

A secondary certificate is generated when the identified feed categories are supplied into the identified reaction environment of the identified gasifier for a determined period of operation, and when the outlet section output are sampled, monitored and a data-set is produced.

### Example 1

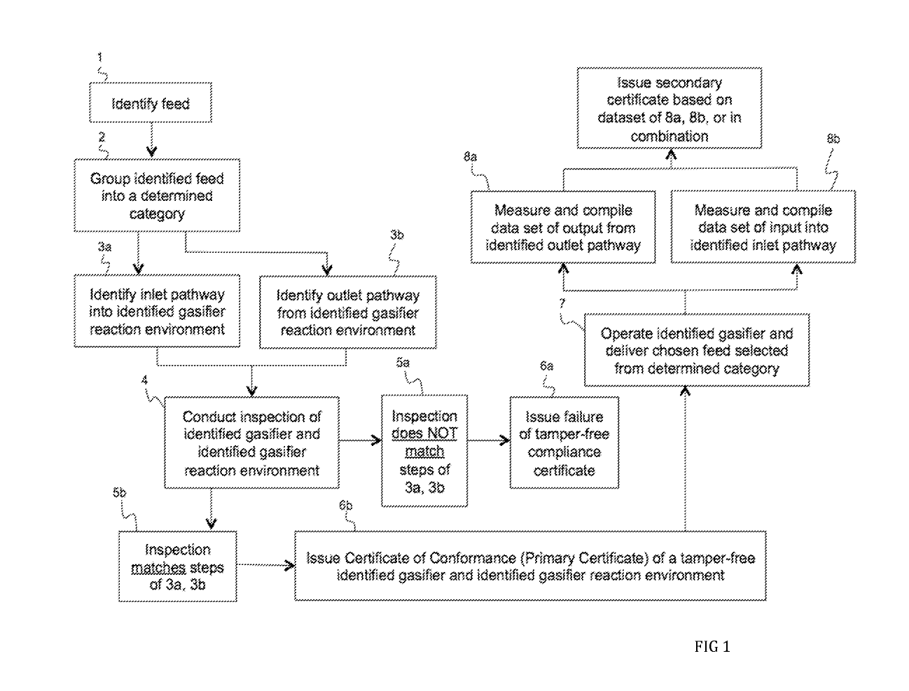

With reference to FIG. 1, the various steps are as follows:

1. A multiplicity of feed is categorized and either delivered into the gasifier as a single feed stream by category, or as a mixed feed stream comprising of all the categorized feeds.

Each feed may be categorized according to a proximal energy content value, fixed carbon composition range, material density, or a combination of such factors, into one or more categorized groups.

For instance, feeds having a energy content value of no less than 3000 kcal/kg and no more than 5000 kcal/kg can be grouped into CLASS 1:
Bituminous coal
RDF
Wood chips G50 size
Shredded plastics 60%—20 mm sized, moisture 20 wt %

Feeds having a high moisture content of greater than 50% are grouped into CLASS 2:
Decomposing wood debris 65% moisture
Sewage sludge 70% moisture
Peat 55% moisture

Feeds having energy content greater than 5,000 kcal/kg are grouped into CLASS 3:
Rubber chips 40%—25 mm sized, average 6000 kcal/kg
Anthracite coal powder, 6,450 kcal/kg
Crude refinery sludge

With reference to FIG. 1, at least one feed 1, is identified and then categorized in a determined group or class 2.

2. The inlets allowing feed and oxidant gas to the gasifier are grouped to an inlet class, while outlets allowing the flow of crude syngas from the gasifier are grouped to an outlet class.

The known gasifier to which primary and secondary certificates are to be applied against is identified, and its mass balance data chart is then matched to the physical inlets where input materials such as the identified feed class (such as CLASS 1) are to be delivered into the reaction environment of the known gasifier.

For instance and depending on the gasifier design, the following may be material inputs:
Feed, single or multiple feed CLASSES.
Air, oxygen, or in combination
Carbon dioxide
Steam
Limestone

In one embodiment the other “input” materials such as air, steam and limestone or any other “additives” are grouped into a distinct category or class, such as CLASS “X”.

The outlets of the gasifier would be chosen from:
Crude syngas (primary output)
Ash
Slag
Dust

In one instance, a known gasifier having a model designation number of A0001 being of the entrained-flow, slagging, gasifier type is designed to use the following feed classes:
CLASS 3, CLASS 1, CLASS “X”.

The known gasifier A0001 is air-driven, at a process temperature of 1560 degrees Celsius and operating pressure of approximately 60 PSIA.

The outlets identified are:
Slagging channel at bottom of the gasifier,
Crude syngas outlet at vertical wall section “A” of the gasifier

The inlets identified are:
CLASS 3, CLASS “X” inlet to pipes 1 and 3 of burner “A” at top of the gasifier
CLASS 1 inlet to pipe 2 and 4 of burner “B” at top of the gasifier
Pre-heated air inlet to pipe 5 of burner “A”
Pre-heated air inlet to pipe 0 of burner “B”

The inlets and outlets are therefore performed at steps 3a, 3h, followed by conducting an inspection at step 4.

3. A tamper-free conformance certificate is issued based on the approved inlet class and outlet class group whereby the inlet class group and outlet class group are traced to a known gasifier reaction process such as a known gasifier mass balance analysis data-set or known gasifier energy balance (Sankey chart) analysis data-set.

This can be implemented by a third party other than the owner of the gasifier or the manufacturer, to ascertain that the number of inlets (6), and the number of outlets (2) are verified and no other conduits are present that may tamper or affect the analytical result of the crude syngas.

This inspection is then issued against a “PRIMARY CERTIFICATE”.

### Operation of the Gasifier

4. The feed is delivered into the gasifier and a sample of crude syngas is collected for chemical and contamination analysis.

A second independent party that is not the previous third party responsible for the inspection and issuance of the Primary Certificate is engaged to conduct the audit and trace of CLASS 1 and CLASS 3, “X” feed being delivered via conduits that are connected to the intended inlet pipes (1, 3, and 2, 4), while at the same time verifying that the outlets are connected to downstream instruments that can measure the crude syngas and slag being the two “authorized” outlet products from the gasifier. These steps are indicated in FIG. 1 from steps 7, 8a, 8b.

5. The gasifier continues to operate with the delivered feed (CLASS 1, 3, “X”) for a determined period of time (500 hours for example) and its crude syngas flowing from the approved outlet class group are then continuously measured and a dynamic outlet data-set is recorded and complied by one or more remote processor.

6. A “Secondary Certificate” is issued based on the data-set complied and traced to a known gasifier bearing a known serial or product number or SKU.

The gasifier with the issued Primary and Secondary certificates serves as a complete documented assurance data-set for the operator and owner of the gasifier, including relevant insurance, warranty and other equipment underwriting parties.

### Example 2 and Data-Set Compilation

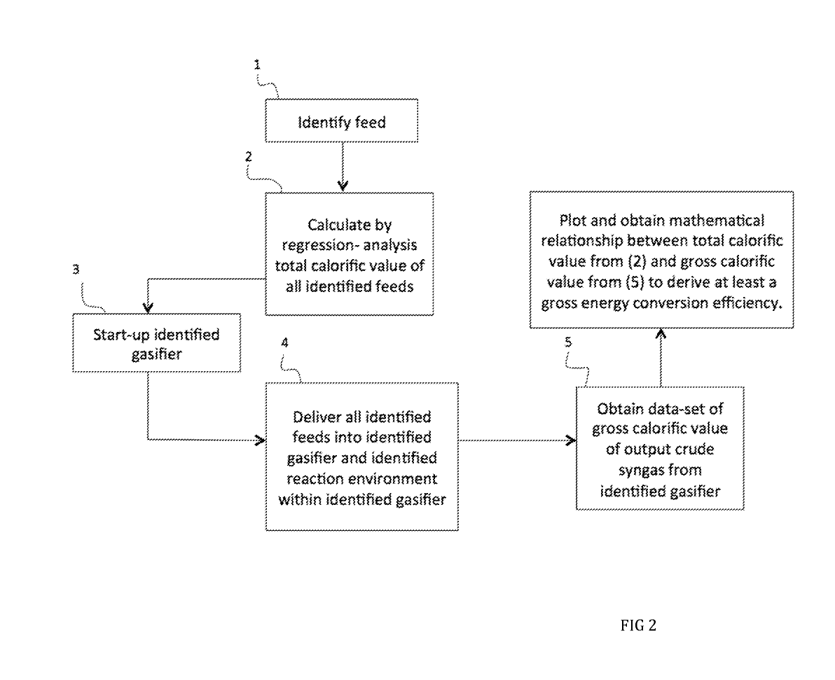

With reference to FIG. 2, the following steps are implemented in accordance to this preferred embodiment of the present invention:
identifying one or more feed fuel to be used in gasifier to convert at least a portion of one or more identified feed fuel to synthesis gas and assigning a calorific value (Cv) to one or more identified feed fuel;
calculating using regression analysis the dependent variable of total calorific value (TLv) by input of the calorific value (Cv) of one or more identified feed fuel; delivering and commissioning of the gasifier and identifying the time period where gasifier is delivered and commissioning is complete for turn-key gasifier initialization;
initializing gasifier by injecting one or more identified feed fuel into contact with at least one identified active reaction zone of gasifier to convert at least a portion of one or more identified feed fuel to synthesis gas and continuously measuring the composition and flow rate (Kd) of exhaust synthesis gas; continuously calculating the gross calorific value (Gcv) of exhaust synthesis gas;
plotting the values of Kd, Gcv and TLv measured and calculated and obtaining the formula of a curve to establish a relationship which correlates the total calorific value TLv and gross calorific value Gcv and deriving a gross energy conversion efficiency value (Gef); measuring the time period to which Gef value is derived and providing the time length value or range, or a combination thereof, of a performance warranty of the gasifier.

### Example 3 for Slagging Type Gasifiers

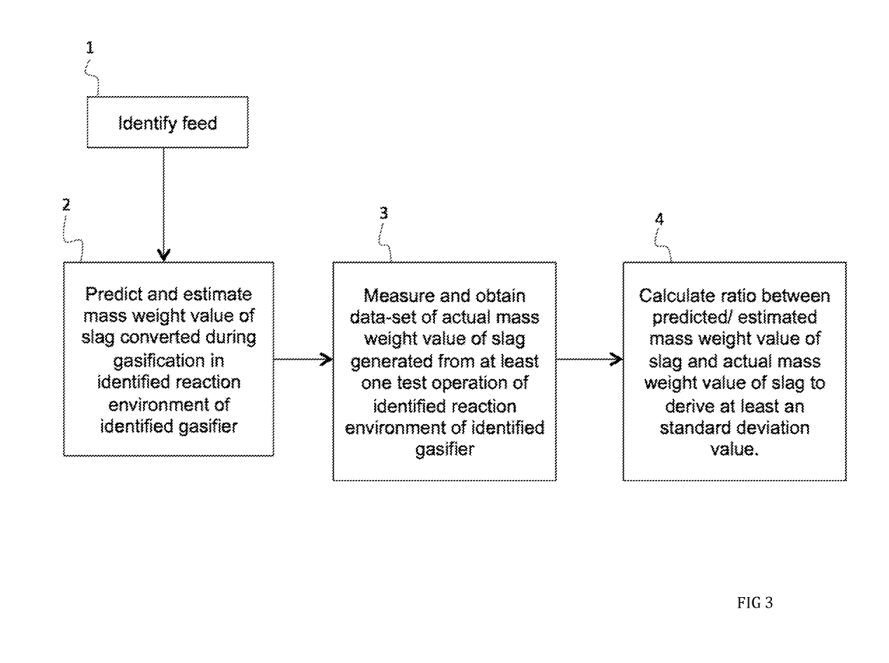

With reference to FIG. 3, the following steps are implemented in accordance to this preferred embodiment of the present invention:
identifying a multiplicity of feed fuel to be used in gasifier to convert at least a portion of one or more identified feed fuel to synthesis gas and calculating using regression analysis the dependent variable of total calorific value (TLv) by input of the calorific value (Cv) of each of multiplicity of feed fuel; predicting and estimating the mass weight of molten slag generated when at least a portion of multiplicity of feed fuel is converted to synthesis gas to derive a value range (Sest);
delivering and commissioning of the gasifier and identifying the time period where gasifier is delivered and commissioning is complete for turn-key gasifier initialization; initializing gasifier by injecting at least a portion of multiplicity of feed fuel into contact with at least one identified active reaction zone of gasifier to convert at least a portion of multiplicity of feed fuel to synthesis gas and continuously measuring the composition and flow rate (Kd) of exhaust synthesis gas;
continuously calculating the gross calorific value (Gcv) of exhaust synthesis gas;
measuring and calculating the actual mass weight of molten slag generated during initialization of gasifier step to derive a value range (Sact); plotting the values of Kd, Gcv and TLv measured and calculated and obtaining the formula of a curve to establish a relationship which correlates the total calorific value TLv and gross calorific value Gcv and deriving a gross energy conversion efficiency value (Gef); calculating the ratio between Sest and Sact and deriving a gross slag conversion index value (Sgv);
measuring the time period to which Gef value is derived and providing the time length value or range, or a combination thereof, of a performance warranty of the gasifier.

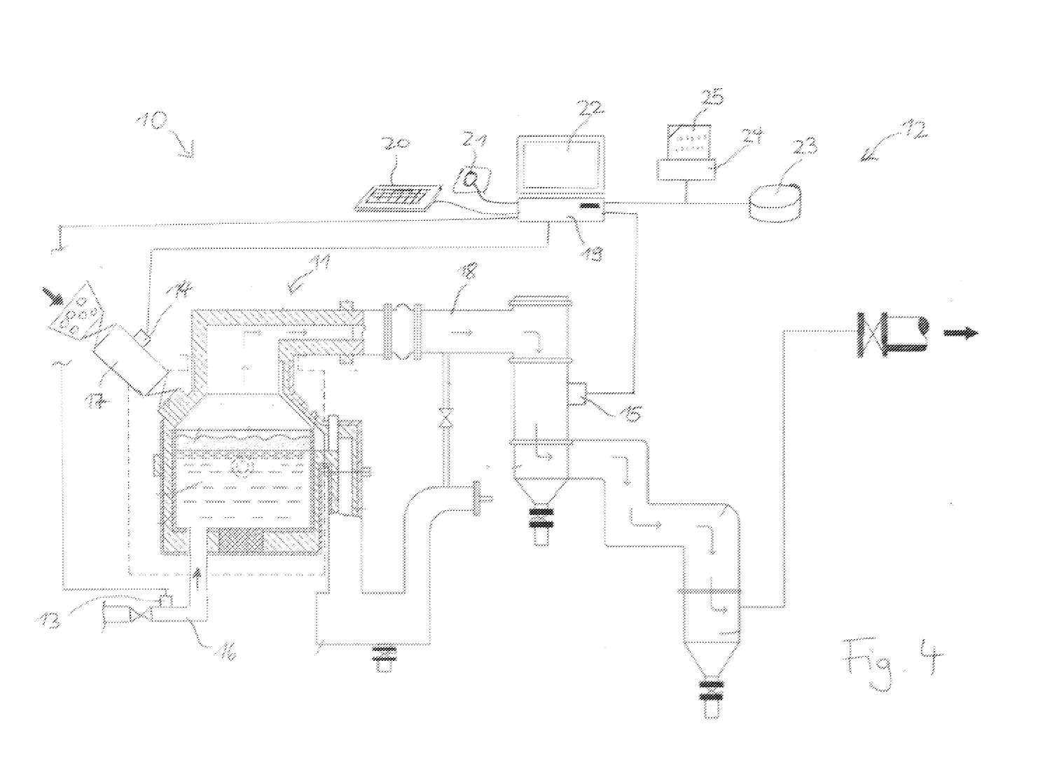

FIG. 4 shows, by way of example, a system 10 for generating performance reports, performance warranties and other documents in accordance with the embodiments of the present specification. It should be noted that the scope of the claims is not limited by the specific example of FIG. 4 but that it is applicable to various different types of gasifiers, sensor arrangements, methods of data collection, data processing devices and so forth.

The system 10 comprises a gasifier 11 and a data capture and processing unit 12. In the example of FIG. 4, the data capture and processing unit 12 is connected to sensors 13, 14, 15 of the gasifier 11 for the automatic capture of data relating to an input supplied to the gasifier 11 and relating to an exhaust gas supplied by the gasifier 11.

In particular, a gas flow sensor 13 is provided at an input conduit 16 for an oxidizing gas, a feed fuel inflow sensor 14 is provided at an inlet 17 for feed fuel, and a calorific value sensor 15 is provided at an exhaust duct 18 of the gasifier 11. The sensors are connected to a computer 19 of the data capture and processing unit 12, by cable, as shown in FIG. 4, and/or by wireless connections.

The data capture and processing system 12 comprises user input devices 20, 21, which are provided by a keyboard 20 and a computer mouse 21. Furthermore, the data capture and processing system 12 comprises a display 21, a data storage and a printer 24 for outputting a hardcopy 25 of a gasifier performance report.

During operation, the data capture and processing system 12 reads in specification values and actual values of the gasifier 11, compares the specification values, or values derived therefrom, with the actual values, or values derived therefrom, and outputs a performance report to the data storage 23 and/or to the printer 24.

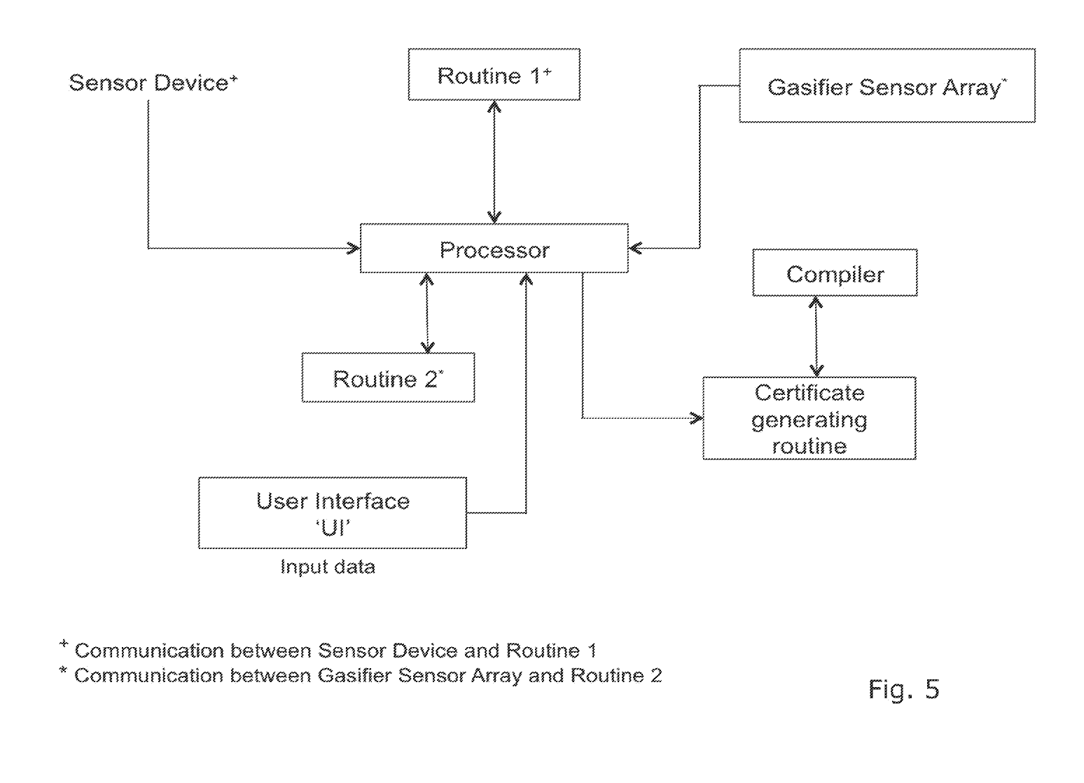

FIG. 5 shows an implementation diagram of a computer implemented method according to the present specification.

One or more sensor devices are connected to a processor, such as for example the sensor 13, 14 or 15 of FIG. 4. Furthermore, a gasifier sensor array, such as far example the sensors 13, 14 of FIG. 4, is connected to the processor. The one or more sensor devices provide input to and are in communication with a first routine while the gasifier sensor array provides input to and is in communication with a second routine. The first and second routine may be provided by software units or they may be provided partially or completely by customized hardware components.

Furthermore, a user interface is provided, such as for example the display, keyboard and painter device of FIG. 4. The user interface can be used to provide or select further input such as guidelines and regulations, predefined performance targets, measured values of process parameters, measured values relating to input and output to the gasifier, or estimated values or values derived from measured and/or estimated values. Furthermore, according to the present specification the user interface can be used to determine and select the information to be generated and the presentation of the information to be generated.

In the context of the present specification, “receiving data” refers to providing input to a computer implemented program via a user interface or via wired or -wireless connections to a computer on which the computer implemented program is executed.

While the various preferred embodiments have been disclosed and described, it will be understood that there they are not to limit the invention by such disclosure, and are intended to cover all modifications, alternative methods and steps within the spirit and scope of the invention as defined in the following claims:

1. A computer implemented method for quality and performance inspection of a gasifier, comprising:
(a) identifying a gasifier;
(b) identifying one or more feed to be delivered into at least one identified inlet conduit belonging to the identified gasifier;
(c) identifying one or more gas, solids, or liquid product to be collected from at least one identified outlet conduit belonging to identified gasifier;
(d) inspecting the identified gasifier against said at least one identified inlet conduit and said at least one identified outlet conduit to determine a match against the steps of (b) and (c);
(e) generating a primary certificate of conformance based on the result of the step of (d);
(f) operating identified gasifier at a remote operating site for a determined time period and delivering one or more identified feed into at least one identified inlet conduit and collecting one or more identified gas, solids, or liquid product from at least one identified outlet conduit;
(g) generating one or more data values from at least the step of (f); and
(h) generating a secondary certificate of conformance based at least from the result of the step of (f), (g), or a combination.

2. The computer implemented method for quality and performance inspection of a gasifier according to claim 1, wherein:
the identification of the gasifier comprises receiving data which characterize the gasifier;
the identification of one or more feed to be delivered into at least one identified inlet conduit belonging to identified gasifier comprises receiving measurement data relating to the feed fuel;
the identification of one or more gas, solids, or liquid product to be collected from at least one identified outlet conduit belonging to identified gasifier comprises receiving measurement data relating to the one or more gas, solids, or liquid product to be collected;
the inspection of the identified gasifier against said at least one identified inlet conduit and said at least one identified outlet conduit to determine a match against the steps of (b) and (c), comprises comparing one or more performance indicators derived from the received measurement data against performance indicators for the gasifier identified in step (a);
the generation of a primary certificate of conformance based on the result of the step of (d) comprises generating an electronic document or a printed copy according to a predetermined format of the primary certificate of conformance; and
the operation of the identified gasifier at a remote operating site for a determined time period and delivering one or more identified feed into at least one identified inlet conduit and collecting one or more identified gas, solids, or liquid product from at least one identified outlet conduit comprises the automatic collection of gasifier relating to the gasifier at the remote operating site by one or more sensors of the gasifier.

3. A computer implemented method for quality and performance inspection of a gasifier, comprising:
identifying one or more feed fuel to be used in gasifier to convert at least a portion of one or more identified feed fuel to synthesis gas and assigning a calorific value (Cv) to one or more identified feed fuel;
calculating using regression analysis the dependent variable of total calorific value (TLv) by input of the calorific value (Cv) of one or more identified feed fuel; delivering and commissioning of the gasifier and identifying the time period where gasifier is delivered and commissioning is complete for turn-key gasifier initialization;
initializing the gasifier by injecting one or more identified feed fuel into contact with at least one identified active reaction zone of gasifier to convert at least a portion of one or more identified feed fuel to synthesis gas and continuously measuring the composition and flow rate (Kd) of exhaust synthesis gas; continuously calculating the gross calorific value (Gcv) of exhaust synthesis gas;
plotting the values of Kd, Gcv and TLv measured and calculated and obtaining the formula of a curve to establish a relationship which correlates the total calorific value TLv and gross calorific value Gcv and deriving a gross energy conversion efficiency value (Gef); measuring the time period to which Gef value is derived and providing the time length value or range, or a combination thereof, of a performance warranty of the gasifier.

4. A computer implemented method for quality and performance inspection of a gasifier, comprising:
(a) identifying a multiplicity of feed fuel to be used in gasifier to convert at least a portion of one or more identified feed fuel to synthesis gas and calculating using regression analysis the dependent variable of total calorific value (TLv) by input of the calorific value (Cv) of each of multiplicity of feed fuel; predicting and estimating the mass weight of molten slag generated when at least a portion of multiplicity of feed fuel is converted to synthesis gas to derive a value range (Sest);
(b) delivering and commissioning of the gasifier and identifying the time period where gasifier is delivered and commissioning is complete for turn-key gasifier initialization; initializing the gasifier by injecting at least a portion of multiplicity of feed fuel into contact with at least one identified active reaction zone of gasifier to convert at least a portion of multiplicity of feed fuel to synthesis gas and continuously measuring the composition and flow rate (Kd) of exhaust synthesis gas;
(c) continuously calculating the gross calorific value (Gcv) of exhaust synthesis gas;
(d) measuring and calculating the actual mass weight of molten slag generated during initialization of gasifier step to derive a value range (Sact); plotting the values of Kd, Gcv and TLv measured and calculated and obtaining the formula of a curve to establish a relationship which correlates the total calorific value TLv and gross calorific value Gcv and deriving a gross energy conversion efficiency value (Gef); calculating the ratio between Sest and Sact and deriving a gross slag conversion index value (Sgv); and
(e) measuring the time period to which Gef value is derived and providing the time length value or range, or a combination thereof, of a performance warranty of the gasifier.

5. The computer implemented method of claim 4, wherein:
the step c) comprises measuring the calorific value of the exhaust gas of the delivered and commissioned gasifier with a calorific value sensor; and
the step d) comprises receiving one or more measured values from one or more sensors of the gasifier and calculating with a computer implemented calculation routine and based on the one or more received measured values the actual mass weight of molten slag generated during initialization of gasifier step of the delivered and commissioned gasifier.

6. A computer program product comprising computer readable instructions for executing the method of claim 1.

7. A computer readable storage medium comprising the computer program product of claim 6.

8. A computer program product comprising computer readable instructions for executing the method of claim 3.

9. A computer readable storage medium comprising the computer program product of claim 8.

10. A computer program product comprising computer readable instructions for executing the method of claim 4.

11. A computer readable storage medium comprising the computer program product of claim 10.
